(19) United States
(12) Patent Application Publication
(10) Pub. No.: US 2015/0317253 A1
(43) Pub. Date: Nov. 5, 2015

(54) IMAGE PROCESSING APPARATUS, METHOD OF CONTROLLING THE SAME, PROGRAM AND STORAGE MEDIUM

(71) Applicant: SQUARE ENIX HOLDINGS CO., LTD., Tokyo (JP)

(72) Inventor: Jean-François F FORTIN, Montreal (CA)

(73) Assignee: SQUARE ENIX HOLDINGS CO., LTD., Tokyo (JP)

(21) Appl. No.: 14/649,282

(22) PCT Filed: Jan. 29, 2014
(86) PCT No.: PCT/JP2014/052591

§ 371 Date: Jun. 3, 2015

Related U.S. Application Data
(60) Provisional application No. 61/761,311, filed on Feb. 6, 2013.

(51) Int. Cl. G06F 12/08

(52) U.S. Cl. CPC G06F 12/0862; G06F 2212/1021; G06F 2212/602

(57) ABSTRACT

An information processing apparatus acquires a command including a load request for data stored beforehand, generates a hash value for the command by applying a hash function for the command, reads out and loads into a loading region, corresponding data in accordance with the load request included in the command. In addition, the apparatus associates and manages the hash value for the command and the corresponding data loaded into the loading region.

### TECHNICAL FIELD

The present invention relates to an information processing apparatus, a method of controlling the same, a program and a storage medium, and particularly relates to a technique for optimizing loading of data used in rendering into a loading region.

### BACKGROUND ART

In recent years, as information communication techniques using networks such as the Internet have developed, services have been provided to customers via networks in various fields. In one such service, in so-called cloud-based gaming, screens rendered on a server are provided to client devices via a network. In this service, the server acquires information of operations performed on a client device, for example, and by rendering screens changed in correspondence with the operations and providing them to the client device, screen display on the client device can be updated. In other words, in cloud-based gaming, for example, even if a user does not have a client device having sufficient rendering capabilities, the user can play a game equivalent to that which can be played on a device having sufficient rendering capabilities.

Note, for content having details that change in real-time in accordance with operations, as with a game, it is necessary to perform rendering processing for screens for every frame. Rendering processing is performed by, for example, a GPU loading data of a rendering object included in a screen into cache memory, and using the data in predetermined calculations, generating screen pixels sequentially in a VRAM which are a final output in accordance with the calculation results. Normally, in rendering processing of one screen, rendering objects included in rendering scope corresponding to the screen are selected in order, data of the rendering objects is loaded into a cache memory, and calculation and rendering processing is repeatedly performed.

Meanwhile, for content for which, for example, a 3D scene, or the like, is rendered, there are cases where multiple rendering objects that have common identical data, or have partially common data, in a rendering target scene (model data, etc.) are arranged. In such a case, because processing resources for loading decrease, reuse of data loaded into the cache memory is advantageous. Also, because there are opportunities to use similar rendering objects in consecutive frames, and not just within single frames, in games executed on, for example, home-use video game consoles, PCs, and the like, there are cases in which frame rendering processing is executed having loaded all necessary data into the cache memory beforehand.

In contrast to this, in cases in which one server renders and provides screens to multiple client devices, such as with cloud-based gaming, the amount of cache memory that can be allocated to one client device is basically restricted. Accordingly, in services such as cloud-based gaming in which multiple client devices can simultaneously connect, loading all necessary data beforehand into cache memory, as with a home-use video game console, is not realistic, and so there is a need to optimize data loading. Furthermore, in cases where identical content is provided to multiple client devices, because the state of progress is different for each client device, an independent process is executed for each device. However, in cases of identical content, a portion of the rendering objects, such as, for example, 2D display of a GUI, or the like, and operation characters, because rendering is performed independently of the state of progress, there has been a possibility of multiple data items of identical rendering objects being loaded in the cache memory of the server, as shown in FIG. 3.

### SUMMARY OF INVENTION

The present invention was made in view of such problems in the conventional techniques. The present invention provides an information processing apparatus, a method of controlling the same, a program and a storage medium for optimizing loading into a loading region of data used for processing.

The present invention in its first aspect provides an information processing apparatus comprising: acquisition means for acquiring a command including a load request for data stored beforehand; generation means for generating a hash value for the command by applying a hash function for the command; loading means for reading out, and loading into a loading region, corresponding data in accordance with the load request included in the command; and management means for associating, and managing, the hash value for the command and the corresponding data loaded into the loading region.

The present invention in its second aspect provides a method of controlling an information processing apparatus comprising: an acquisition step of acquiring a command including a load request for data stored beforehand; a generation step of generating a hash value for the command by applying a hash function for the command; a loading step of reading out, and loading into a loading region, corresponding data in accordance with the load request included in the command; and a management step of associating, and managing, the hash value for the command and the corresponding data loaded into the loading region.

Further features of the present invention will become apparent from the following description of exemplary embodiments with reference to the attached drawings.

### BRIEF DESCRIPTION OF DRAWINGS

FIG. 1 is a view for showing a system configuration of a screen provision system in accordance with an embodiment of the present invention;

FIG. 2 is a block diagram for showing a functional configuration of a server 100 in accordance with the embodiment of the present invention;

FIG. 3 is a view for explaining conventional data loading into a cache memory by multiple processes;

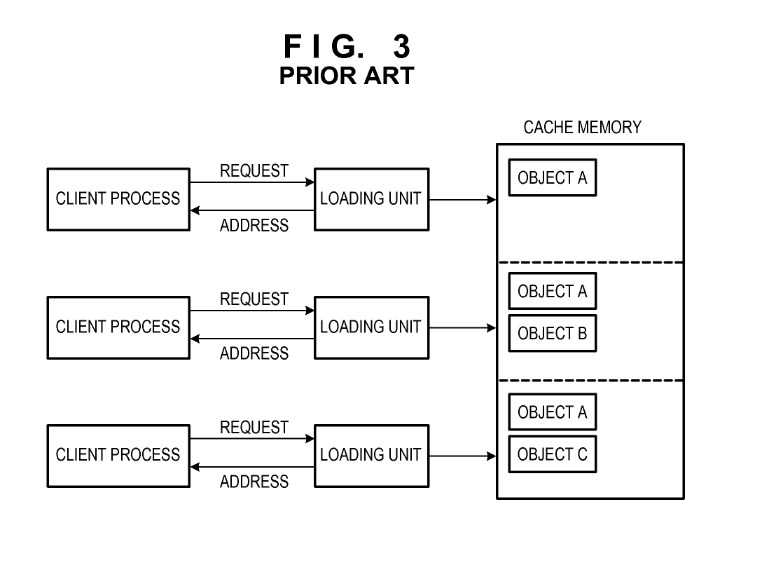

FIG. 4 is a view for explaining an operation of data loading into a cache memory 105 in accordance with the embodiment of the present invention;

FIG. 5 illustrates the general architecture of information managed by a management unit 107 in accordance with the embodiment of the present invention;

FIG. 6 is a flowchart which exemplifies loading processing performed by a GPU 104 in accordance with the embodiment of the present invention;

### DESCRIPTION OF EMBODIMENTS

Below, detailed explanation will be given for the exemplary embodiment of the present invention, with reference to the drawings. Note, the embodiment explained below is only an example in which the present invention is adopted so as to have a server capable of rendering, in parallel, screens to be provided to multiple client devices as an example of the information processing apparatus. Nevertheless, the present invention can be adopted to various devices capable of loading data into a loading region and repeatedly executing processing using the loaded data. In other words, the present invention is not limited to data loading to a loading region in rendering processing, and can be adopted to data loading into a loading region in various kinds of processing.

<Screen Provision System Configuration>

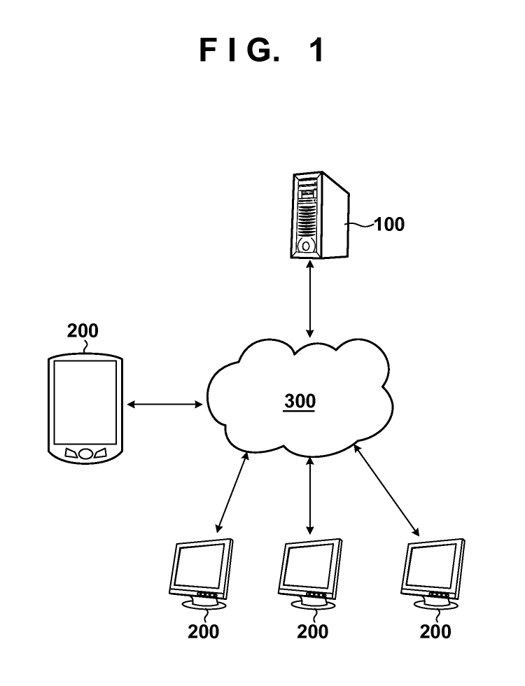

FIG. 1 is a view for showing a system configuration of a screen provision system in accordance with the embodiment of the present invention. The present system realizes cloud-based gaming.

A server 100 renders screens for games provided in the cloud-based gaming service (game screens), and outputs these as coded video data in a streaming format to a client device 200. Note, in the embodiment, explanation is given having the server 100 have a rendering function, but the present invention is not limited to this. For example, a configuration, in which an external rendering server specialized for rendering processing performs screen rendering in accordance with commands output from the server 100, and outputs generated game screens, may also be taken. Also, in the embodiment, for simplicity, explanation is given having client devices 200, which connect to the server 100, be capable of using a single game content item at the same time, but working of the present invention is not limited to this.

Each of the client devices 200 connect to the server 100 via a network 300 in order to receive provision of the service. The client devices 200 are not limited to PCs and stationary game devices, and may also be mobile terminals such as mobile telephones, smart phones and portable game devices. Also, the network 300 is not limited to a public communication network such as the Internet, and may be a LAN or a communication configuration in which the server 100 and the client devices 200 have direct wired or wireless connections. The client devices 200 have an operation input interface, and transmit information indicating operation input performed by a user to the server 100, or transmit to the server 100 having applied predetermined processing to information indicating the operation input.

The server 100 acquires the information for operation input from the client devices 200 via the network 300 and generates a game screen by performing predetermined calculations and rendering processing for a frame to be rendered. Next, the server 100 encodes the screen, for example, into video data, and transmits to the corresponding client device 200. The client device 200 performs predetermined processing such as decoding when it receives the video data, and outputs a video signal to a display device of the client device 200 or a display device connected to the client device 200 to cause the video to be displayed. By doing this, game screen provision to the user of the client device 200 in the screen provision system is realized.

Note, in the embodiment, explanation is given having multiple client devices 200 connect to the server 100 in parallel, and each receive provision of game screens, but the present invention is not limited to this, and for each client device 200 there may be one server 100.

<Server 100 Functional Configuration>

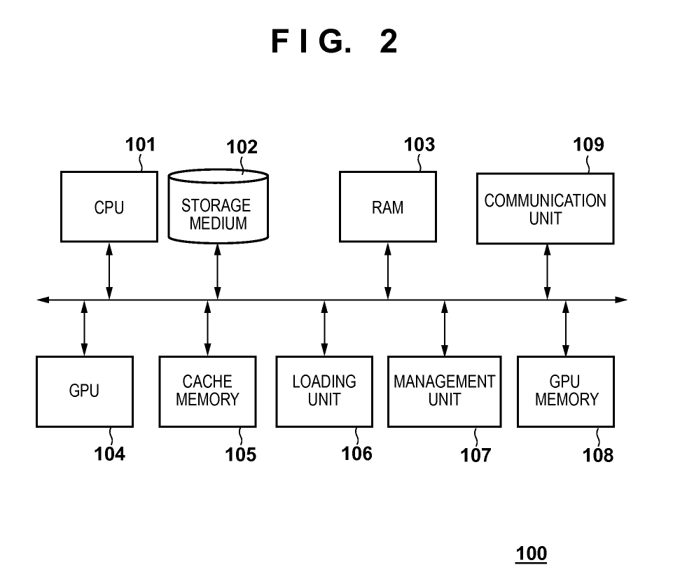

FIG. 2 is a block diagram for showing a functional configuration of the server 100 in accordance with the embodiment of the present invention.

A CPU 101 controls operation of various blocks of the server 100. Specifically, the CPU 101 is capable of controlling operation of blocks by reading out a game program recorded in a storage medium 102, loading it into a RAM 103, and executing it.

The storage medium 102 may be a non-volatile memory such as an HDD or a rewritable ROM. In the storage medium 102, not only game programs for game content provided to the client devices 200, but also various parameters necessary in the game program are recorded. Also, in the storage medium 102, data of rendering objects necessary in the generation of game screens is recorded. The data of the rendering objects may include not only model data and texture data, for example, but also rendering programs such as a shader to be used, and calculation data used by such rendering programs (constants such as light source intensity, variables such as light source vectors and rotation matrices, etc.). Note, data of the rendering objects need not include all of the model data, texture data, rendering programs and calculation data, and may have any of these.

The RAM 103 is a volatile memory. The RAM 103 is used not only as a loading region of game programs, but also as a storage region for temporarily storing such things as intermediate data output in the operation of the various blocks.

The GPU 104 performs rendering processing for game screens having received instruction from the CPU 101. Specifically, the GPU 104, in a case where a rendering instruction was made using an API prepared beforehand during execution of a game program, for example, receives a rendering command corresponding to the instruction via a driver. In the embodiment, the GPU 104 has a cache memory 105 which is a loading region for temporarily loading and maintaining data necessary for rendering.

Loading to the cache memory 105 is performed by a loading unit 106. Upon receiving a load request from the CPU 101 via a management unit 107, the loading unit 106 reads out corresponding data from the storage medium 102 in accordance with the load request and loads it into the cache memory 105. On the other hand, the management unit 107 manages data loaded into the cache memory 105. The GPU 104 performs rendering of game screens into a GPU memory 108 using data loaded into the cache memory 105 in accordance with a rendering command.

Note, in the embodiment, for simplicity, explanation is given having sharing of one cache memory 105 in game programs performed for the multiple client devices 200, but configuration may be taken in which cache memory 105 is broken into multiple regions. In such cases, a management unit 107, for example, may manage data loaded into the regions.

A communication unit 109 is a communication interface of the server 100. The communication unit 109 is capable of performing data transmission and receiving with the client devices 200 via the network 300. Specifically, the communication unit 109 performs receiving of information of operation input performed in the client devices 200, and performs transmission of game screens rendered into the GPU memory 108 (in the embodiment, the game screens are encoded video data) to corresponding client devices 200. The data transmission and receiving includes such things as conversion to a data format for a predetermined communication mode, and conversion from that format to a format processable on the server 100.

<Operation Overview>

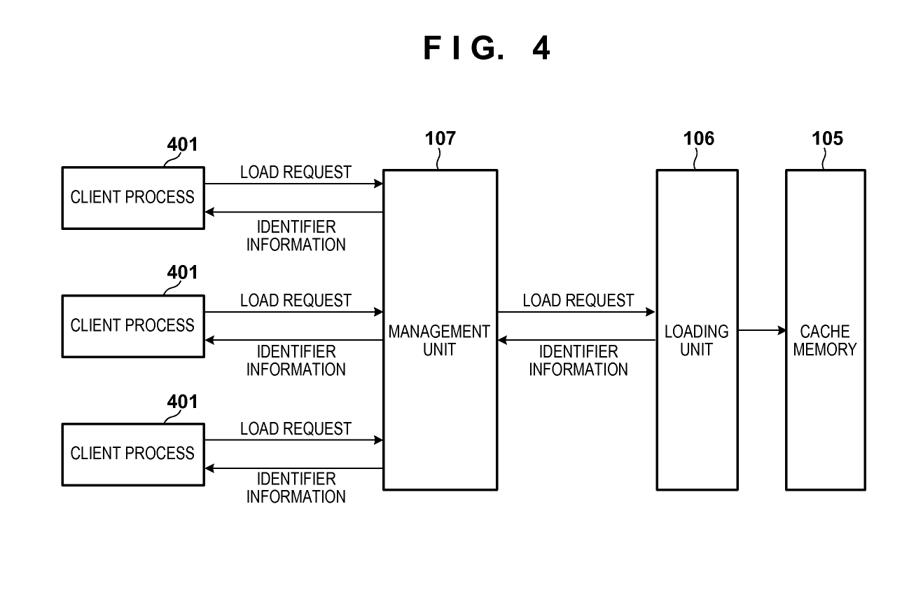

Explanation of a loading operation performed in processes corresponding to programs that the CPU 101 executes (client process 401) in cases where game programs are being executed in parallel for multiple client devices 200 for the server 100 according the embodiment thus configured will be given using FIG. 4.

In cases where each client process 401 issues a rendering command, the client process 401 outputs the load request to the management unit 107. Here, the management unit 107 determines whether or not data (hereinafter called “corresponding data”), for which loading is necessary due to the load request, is already loaded into the cache memory 105. In the embodiment, the management unit 107 determines whether or not the corresponding data is already loaded into the cache memory 105 by determining whether or not a hash value, obtained by applying a predetermined hash function to information indicating the load request, is the same as a hash value for a previously performed load request. The hash function used in the management unit 107 is a function defined to output an identical hash value in a case where it is applied to load requests having identical details out of multiple load requests, and to output different hash values in a case where it is applied to load requests having different details out of multiple load requests. For the hash function, a conventional function such as, for example, CRC32, SHA1, xxhash, Murmurhash3, or CityHash, a function that improves upon any of these, or an independently developed function may be used as appropriate. Also, in the embodiment, explanation is given having the hash function be applied to the load request (i.e. a predetermined structure defining the load request), but working of the present invention is not limited to this. The hash function may also be something that is applied to the entire command including the a load request (for example a rendering command), or a combination of parameters relating to an instruction for the loading and information indicating the specific type of the instruction (for example, an extraction command or a scaling command for texture data) (information of a part of a structure). Note, the hash function outputs fixed length data for variable length data. Therefore, it is easy to identify any block of data by a hash value which is obtained by using the hash function.

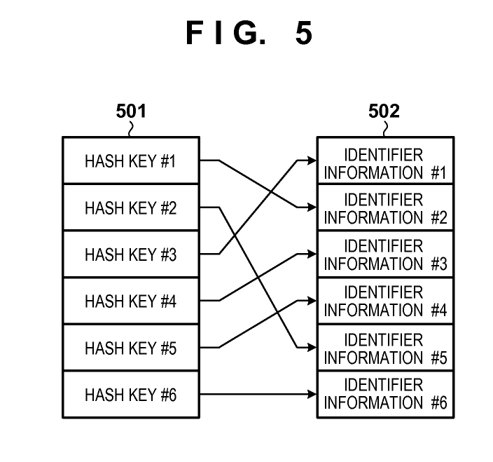

The management unit 107 transmits the load request to the loading unit 106 in a case where corresponding data does not exist in the cache memory 105, reads out the corresponding data, and loads it into the cache memory 105. Here, the management unit 107 receives identifier information identifying a position in the cache memory 105 of the loaded corresponding data from the loading unit 106. The management unit 107 associates the hash value, as a hash key 501, generated for the load request of the corresponding data with received identifier information 502 and manages, as in FIG. 5. Also, the management unit 107 returns the identifier information of the corresponding data to the client process 401.

FIG. 5 illustrates the general architecture of information managed by the management unit 107. (management information). The management unit 107 stores identifier information 502 of the data and associates each identifier information item with a respective key 501. Keys are unique such that a single key points to a single piece of identifier information 502.

The management unit 107, in a case where the corresponding data is already loaded into the cache memory 105, returns, to the client process 401, the identifier information of the corresponding data associated with the identical hash value to the generated hash value. Note, in this embodiment, since the screen rendering is performed sequentially for consecutive frames, the cache memory 105 maintains the loaded corresponding data over a plurality of frames, and the management unit 107 also maintains the hash key 501 and the identifier information 502 over a plurality of frames. Therefore, the management unit 107 returns the identifier information of the corresponding data loaded in accordance with a load request included in a command made for the same frame or in a command made for a preceding frame.

By doing this, the CPU 101 of the embodiment is able to easily determine whether data is loaded into the cache memory 105 already in a case where it is necessary to load common data in, for example, a different client process 401 or in the same client process 401.

<Loading Processing>

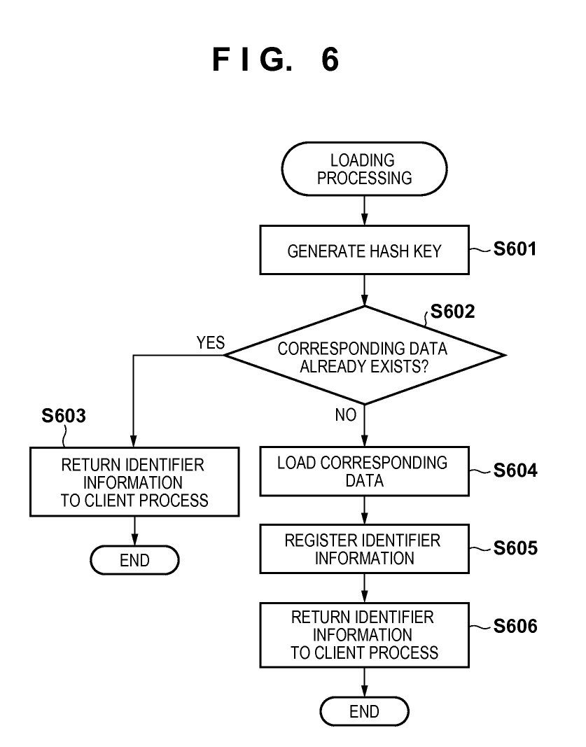

Next, explanation of details of the specific loading processing performed by the CPU 101 in order to realize the operation explained in the operation overview will be given using the flowchart of FIG. 6. Note, explanation is given having the loading processing initiated when the management unit 107 receives information of the load request from one of the client processes 401 executed on the CPU 101.

At step 601, the management unit 107 generates the hash key based on the load request. In the example where the load request is included in a rendering instruction, the load request is processed by a suitable algorithm (hash function) to generate the key. In a specific mode of implementation, a key is generated for a plurality of load requests. Optionally, the management unit 107 may be designed with a load request filter to trap specific types of the load request that are most likely to be sharable. This may be useful from an efficiency perspective in avoiding generating keys that are unlikely to lead to data sharing.

Referring back to FIG. 6, once the hash key has been generated, in step 602, the management unit 107 determines if data corresponding to the load request (corresponding data) already exists in the cache memory 105. Specifically, the management unit 107 performs the determination in accordance with whether or not identifier information with which an identical hash key is associated exists amongst information managing data loaded into the cache memory 105 (management database). The existence of the same key implies that the same corresponding data has been sought previously by the same or by a different client process and it already exists in the cache memory 105. Therefore, the corresponding data can be re-used and it is not necessary to generate it one more time. The management unit 107 moves the processing on to step 603 in a case where it determines that the corresponding data already exists, and moves the processing on to step 604 in a case where it determines that it does not exist in the cache memory 105.

At step 603, the management unit 107 provides the client process with identifier information of the corresponding data. Then the management unit 107 ends the loading processing. This can be done by returning to the client process, via the logical output of the management unit 107, an address of the location or a pointer (or a handler) where the corresponding data can be accessed.

If it is determined that the corresponding data does not exist in the cache memory 105, the management unit 107, in step 604, transmits the load request to the loading unit 106, reads out the corresponding data from the storage medium 102 and loads it into the cache memory 105. When the loading unit 106 completes the loading of the corresponding data it transmits the identifier information of the corresponding data to the management unit 107.

At step 605, the management unit 107 registers the identifier information received from the loading unit 106 to the management database. The registration process involves creating a new entry in the management database that links the key computed in connection with the request with the newly created corresponding data.

Note, in step 604, there are times where the loading unit 106 uses a region that overlaps data already loaded into the cache memory 105 by loading the corresponding data. Because, in such a case, the data that was loaded in the corresponding region will be partially or entirely destroyed, there is a necessity for the management unit 107 to release the management of the data from the management database. Accordingly, in this step, the management unit 107, referencing the identifier information received from the loading unit 106, performs processing for deleting an entry having identifier information for an overlapping address range in which the target data is loaded.

Also, in step 606, the management unit 107 provides the received identifier information to the client process that transmitted the load request information, and ends the loading processing.

In this way, it can be easily determined that a load request is the same by using a hash value obtained by applying a hash function to the request in the server 100 of the embodiment. Also, through managing by associating the hash value for the load request with data loaded into the loading region in accordance with the load request, it is possible to determine easily whether or not load target data exists in the loading region in a case where there was a load request indicating an identical hash value.

Note, in the embodiment, explanation was given having the data loaded into the cache memory 105 contend for loading addresses (i.e. to continue to exist so long as it was not overwritten), but the present invention is not limited to this.

For example, if there is no opportunity to reuse data even though it has be loaded into the cache memory 105, there is a low necessity of managing the data. Also, managing data for which there is no value in reuse may cause the determination target number to increase for the determination of whether identical data exists. Furthermore, because the data lengths of loaded data are not all identical, data having a high value in reuse may be destroyed by data having a long data length but little value in reuse, resulting in the data having to be loaded once again. Accordingly, control may be performed so as to prioritize, having evaluated value in reuse (i.e. whether or not the data will actually be reused), the leaving of data having a high value in reuse in the cache memory 105, and control may be performed so that data having a low value in reuse be destroyed sequentially.

This processing is realizable by further managing a count corresponding to a usage frequency for each load data item in the management database that the management unit 107 manages, for example. Specifically, the management unit 107, in, for example, the rendering of one frame, may add to the count in accordance with a request occurrence number for data for which the load request was made, and subtract from the count for data for which not one request was made in the frame. The management unit 107 may be configured so as to remove, in a case where data whose count has dropped to less than or equal to a threshold exists, management of the data and to actively allocate a region being used for storage of corresponding data to data for which the load request has been newly made. Alternatively, the management unit 107 may control so as to remove management for data for which the numeric value of the count does not become a high rank predetermined number ranking. In this case, the management unit 107 supplies information, to the loading unit 106, of the region at which the data to destroy, or the data for which to remove management, is stored, and preferentially causes loading of new data into the region to be performed. Alternatively, configuration may be taken such that information of the region at which data for which the count is greater than or equal to a threshold exists is supplied to the loading unit 106 and loading of new data to such a region is not performed. By doing this, data having a high value in reuse can be preferentially left, and data having a low value in reuse can be sequentially destroyed. Note, explanation was given for increasing/decreasing the count during one frame, but this is just to simply illustrate one example, and configuration may also be taken to perform the increasing/decreasing of the count based on processing for any time period.

As explained above, it is possible for the information processing apparatus of the embodiment to optimize loading to a loading region of data used in processing. Specifically, the information processing apparatus acquires a command including a load request for data that was stored beforehand, and generates a hash value for the command by applying a hash function to the command. Also, the information processing apparatus manages by associating corresponding data loaded into the loading region in accordance with the load request included in the command and the hash value for the command.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the information processing apparatus and the method of controlling the same according to the present invention are realizable by a program executing the methods on a computer. The program is providable/distributable by being stored on a computer-readable storage medium or through an electronic communication line.

This application claims the benefit of U.S. Provisional Patent Application No. 61/761,311, filed Feb. 6, 2013, which is hereby incorporated by reference herein in its entirety.

1. An information processing apparatus comprising:
an acquirer which is able to acquire a command including a load request for data stored beforehand;
a generator which is able to generate a hash value for the command by applying a hash function for the command;
a loader which is able to read out, and to load into a loading region, corresponding data in accordance with the load request included in the command; and
a manager which is able to associate, and to manage, the hash value for the command and the corresponding data loaded into the loading region.

2. The information processing apparatus according to claim 1, wherein said loader does not perform loading of the corresponding data into the loading region in a case where the hash value for the command is identical to the hash value associated with data loaded into the loading region already.

3. The information processing apparatus according to claim 1 wherein
the data loaded into the loading region is configured to be destroyed in a case where a predetermined condition is satisfied, and wherein
said manager controls, in a case where the hash value for the command is identical to the hash value associated with data loaded into the loading region already, so that the data is less likely to be destroyed than other data loaded into the loading region.

4. The information processing apparatus according to claim 1, further comprising
an output unit which is able to output, for the command, information for identifying the corresponding data loaded into the loading region in accordance with the load request included in the command, and wherein
said output unit outputs information for identifying the data loaded into the loading region already in a case where the hash value for the command is identical to the hash value associated with data loaded into the loading region already.

5. The information processing apparatus according to claim 4, wherein
the command is a command made to a renderer upon screen rendering,
the load request included in the command requests loading of data used for screen rendering, and
said output unit outputs, to said renderer, information for identifying the data loaded into the loading region in accordance with the load request included in the command.

6. The information processing apparatus according to claim 5, wherein
the screen rendering is performed sequentially for consecutive frames,
the data loaded into the loading region is maintained over a plurality of frames, and
said output unit outputs information for identifying, upon screen rendering of a frame, the data loaded into the loading region in accordance with a load request included in a command made for the same frame or in a command made for a preceding frame.

7. The information processing apparatus according to claim 5, wherein
said acquirer acquires, in parallel, the command for screen rendering for a screen to be provided to a plurality of devices,
said loader shares the loading region for loading of data for a load request for screen rendering for a screen to be provided to the plurality of devices, and
said output unit outputs, upon screen rendering for a screen to be provided to one device, information for identifying the data loaded into the loading region in accordance with the load request included in the command for screen rendering for a screen to be provided to a different device.

8. The information processing apparatus according to claim 5, wherein the hash function is a function for generating a hash value by being applied to any of an entire command for screen rendering, a load request, or a combination of parameters related to a loading instruction and information indicating a type of the instruction.

9. The information processing apparatus according to claim 5, wherein the data used in the screen rendering includes at least one of rendering object model data, texture data, a rendering program or calculation data used by a rendering program.

10. A method of controlling an information processing apparatus comprising:
acquiring a command including a load request for data stored beforehand;
generating a hash value for the command by applying a hash function for the command;
loading including reading out, and loading into a loading region, corresponding data in accordance with the load request included in the command; and
managing including associating, and managing, the hash value for the command and the corresponding data loaded into the loading region.

11. The method of controlling the information processing apparatus according to claim 10, wherein in said loading, loading of the corresponding data into the loading region is not performed in a case where the hash value for the command is identical to the hash value associated with data loaded into the loading region already.

12. The method of controlling the information processing apparatus according to claim 10, wherein
the data loaded into the loading region is configured to be destroyed in a case where a predetermined condition is satisfied, and wherein
in said managing, control is performed, in a case where the hash value for the command is identical to the hash value associated with data loaded into the loading region already, so that the data is less likely to be destroyed than other data loaded into the loading region.

13. The method of controlling the information processing apparatus according to claim 10, further comprising
outputting, for the command, information for identifying the corresponding data loaded into the loading region in accordance with the load request included in the command, and wherein
in said outputting, information for identifying the data loaded into the loading region already is output in a case where the hash value for the command is identical to the hash value associated with data loaded into the loading region already.

14. The method of controlling the information processing apparatus according to claim 13, wherein
the command is a command made to a renderer upon screen rendering,
the load request included in the command requests loading of data used for screen rendering, and
in said outputting, information for identifying the data loaded into the loading region, is output to said renderer, in accordance with the load request included in the command.

15. The method of controlling the information processing apparatus according to claim 14, wherein
the screen rendering is performed sequentially for consecutive frames,
the data loaded into the loading region is maintained over a plurality of frames, and
in said outputting, information for identifying the data loaded into the loading region is output, upon screen rendering of a frame, in accordance with a load request included in a command made for the same frame or in a command made for a preceding frame.

16. The method of controlling the information processing apparatus according to claim 14, wherein
in said acquiring, the command for screen rendering for a screen to be provided to a plurality of devices is acquired in parallel,
in said loading, the loading region for loading of data for a load request for screen rendering for a screen to be provided to the plurality of devices is shared, and
is said outputting, upon screen rendering for a screen to be provided to one device, information for identifying the data loaded into the loading region is output in accordance with the load request included in the command for screen rendering for a screen to be provided to a different device.

17. The method of controlling the information processing apparatus according to claim 14, wherein the hash function is a function for generating a hash value by being applied to any of an entire command for screen rendering, a load request, or a combination of parameters related to a loading instruction and information indicating a type of the instruction.

18. The method of controlling the information processing apparatus according to claim 14, wherein the data used in the screen rendering includes at least one of rendering object model data, texture data, a rendering program or calculation data used by a rendering program.

19. (canceled)

20. A non-transitory computer-readable storage medium storing a program for causing a computer to function to execute each step of the method of controlling the information processing apparatus according to claim 10.
